(19) United States
(12) Patent Application Publication
(10) Pub. No.: US 2002/0161612 A1
(43) Pub. Date: Oct. 31, 2002

(54) Method of providing focused resources and managed infrastructure customized to a particular concern

(76) Inventor: Leonard Jurden, Shawnee Mission, KS (US)

Correspondence Address: HOVEY, WILLIAMS, TIMMONS & COLLINS, Suite 400, 2405 Grand, Kansas City, MO, 64108, US

(21) Appl. No.: 09/843,965

(22) Filed: Apr. 27, 2001

(51) Int. Cl. G06F 17/60; G06F 15/173

(52) U.S. Cl. 705/7; 709/223

(57) ABSTRACT

A method of providing a focused range of resources, including content and services, limited by and customized to the functions and interests of a particular concern, as well as the managed infrastructure, including hardware and software, necessary to access and use the resources. The content and services may include productivity, curricular, administrative, assessment, collaboration, and professional development programming. The managed infrastructure is provided to the degree desired, depending upon the concern's needs, including installation, training, and upgrades. Such infrastructure may include communications hubs for connecting one or more concern environments to a regional data center, and reliable, low-cost thin client terminals for accessing the resources maintained at the data center. Security features ensure safe communication and system integrity. Additional services may include both pre-operational and ongoing training and responsiveness to ensure that maximum benefit is realized. Relatedly, technical assistance and 24-hour help lines may also be provided.

### BACKGROUND OF THE INVENTION

1. Field of the Invention

The present invention relates to methods for providing focused resources and managed infrastructure. More particularly, the invention relates to a system and method of providing a range of resources, including content and services, customized to the functions, interests, and needs of a particular concern, as well as the managed infrastructure, including hardware and software, necessary to access and use the resources.

2. Description of the Prior Art

A great many specialized concerns desire easily accessible resources focused upon and sensitive to their particular functions, interests, and needs. The nature of these concerns may vary widely from, for example, special interest groups to industries, amateurs to professionals, and localized communities to world-wide organizations. These resources may include, for example, productivity, regulatory, administrative, assessment, collaboration, or professional development-related content and services. Computers and computer networks provide an excellent mechanism for delivering at least a large portion of those resources, particularly to wide-spread or remote concern members. Those with ordinary skill in the art will appreciate, however, that acquiring and maintaining the necessary hardware and software infrastructure can be a time-consuming and expensive process unavailable to or impractical for many concerns. Assuming an ability to surmount the various problems related to acquiring and maintaining the infrastructure, problems then arise related to finding reliable and accessible resources. Computer networks, particularly the Internet, provide a wealth of information as well as access to service providers. Unfortunately, the content of the Internet is so dilute that even sophisticated search engines are unable to access, search, and identify all but a small percentage of available online resources.

Even were a user able to retrieve and consolidate relevant resources, the information is not tailored or customized to the concern's particular needs and desires. Furthermore, though a few generally accessible websites may exist providing useable resources to some degree, the user typically has no assurances as to the content's veracity and validity.

For example, schools, educational administrators, teachers, students, parents, and other members of an educational concern desire and would benefit greatly from educationally focused content and services tailored to meet their specific needs. Online, computer-accessible service providers exist that deliver such limited resources as generalized core curriculum instruction, message boards, chat/discussion groups, and relevant products (books, software, etc.). Unfortunately, though sometimes helpful, these resources are typically not comprehensive, being instead limited to only one or a few content areas or services. Also, these resources are typically not tailored or customized to the particular needs or desires of the concern, being instead designed for much broader consumption and applicability. Furthermore, the various providers have no agreement with and owe no duty to the concern to monitor and maintain reliability, veracity, and appropriateness of the resources. Relatedly, providers of generally available content may not protect user data or provide security for legitimate users. This latter issue is of particular importance with regard to online chatrooms, where anonymous users may have improper motives.

Thus, currently, a concern desiring access to a range of content and services must first identify, contact, and contract with a number of third-parties, including a first set of suppliers and providers to acquire the necessary infrastructure, maintenance, training, and upgrades, and a second set of providers to acquire access to the desired resources. Furthermore, if the resources must be specially generated, produced, or adapted for the concern, then the involvement of still more providers may become necessary. This large number of uncoordinated third-parties can result in substantial infrastructural and resource incompatibility, unadaptability, and unmonitored obsolescence.

For these and other reasons, an improved method of providing focused resources and infrastructure is needed.

### SUMMARY OF THE INVENTION

The present invention solves the above-described and other problems and provides a distinct advance in the art of providing focused resources and managed infrastructure. Specifically, the method of the present invention provides a range of resources, including content and services, limited by and customized to the functions and interests of a particular concern, as well as the managed infrastructure, including hardware and software and ongoing support, necessary to access and use the resources. Thus, the present invention eliminates dealing with multiple vendors and providers of content and services; solves availability, compatibility, and obsolescence issues; and results in comprehensive, one-stop focused resource accessibility.

Managed infrastructure is provided to the degree desired, depending upon the concern's needs, including installation, management/support, training, and upgrades. Less affluent concerns are able to participate because the infrastructure is provided on a subscription or similar basis rather than requiring a large up-front capital investment. Infrastructure includes communications hubs for connecting one or more concern environments to a regional data center. Terminals, preferably simple, reliable, low-cost “thin client” terminals, are provided to allow concern members to access the resources maintained at the data center. Security features ensure safe communication and system and data integrity.

Additional benefits include both pre-operation and ongoing training seminars to ensure that maximum benefit is realized. Relatedly, technical assistance and help lines are also provided.

The invention has broad applicability to various concerns, including, for example, education concerns comprising schools, school districts and other educational facilities. The resources, whether acquired, licensed, or produced, are customized and tailored to meet the needs of each member subgroup of the educational concern. For example, administrators may desire management tools; educators may desire streaming video presentations by respected experts in far-away universities; students may desire filtered and monitored chat/discussion groups; and parents may desire information regarding the concern's progress toward meeting curriculum standards and goals. The present invention provides all of these resources in one package, ensures veracity and validity, maintains the resources and infrastructure necessary to access and participate in benefitting therefrom, and responds to the concern's desires for adding, deleting, or changing content and services. Additionally, security measures are implemented to protect concern members, such as students chatting in an online chat room component of the present invention, from undesirable outside elements. Security measures are also emplaced to protect member data from unauthorized access.

These and other novel features of the present invention are described in more detail in the section titled DETAILED DESCRIPTION OF A PREFERRED EMBODIMENT, below.

### BRIEF DESCRIPTION OF THE DRAWING FIGURES

The present invention is described in detail below with reference to the attached drawing figures, wherein:

FIG. 1 is a high-level block diagram of a preferred embodiment of a distributed, hierarchal system operable to implement a preferred embodiment of the method of the present invention;

FIG. 2 is a block diagram showing in more detail features of a portion of the block diagram shown in FIG. 1;

FIG. 3 is a block diagram showing in more detail features of a portion of the block diagram shown in FIG. 1; and

FIG. 4 is a block diagram showing the steps involved in the operation of a preferred embodiment of the method of the present invention implemented using the system shown in FIGS. 1, 2, and 3.

### DETAILED DESCRIPTION OF A PREFERRED EMBODIMENT

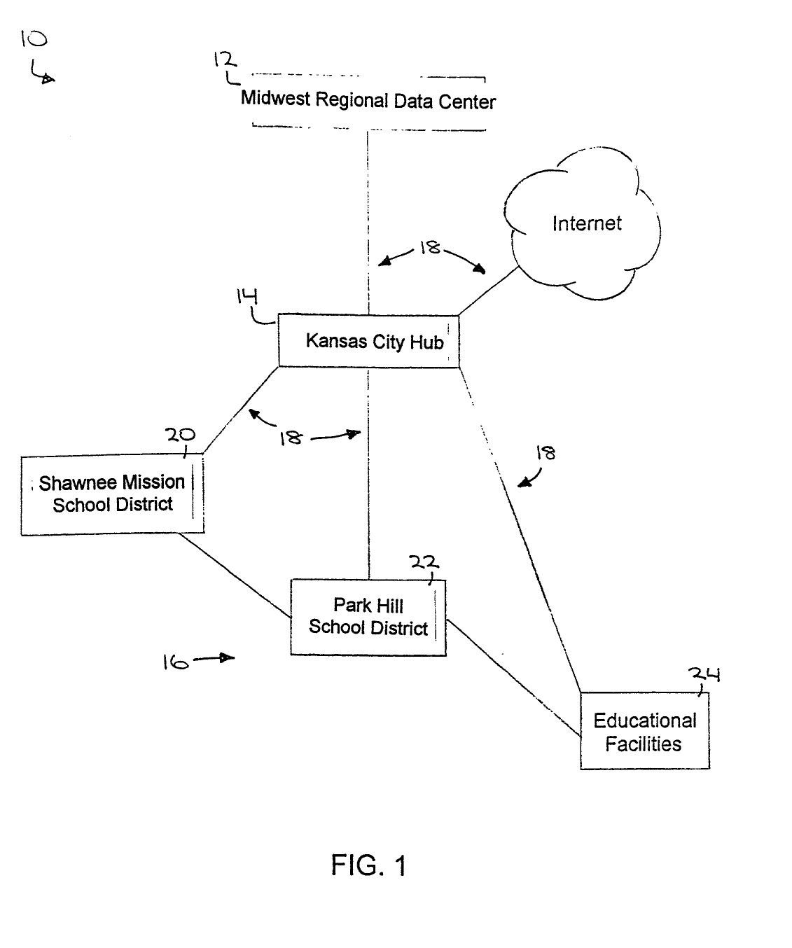

A preferred distributed system 10 is shown in FIG. 1 with which the method of the present invention may be implemented. It should be noted, however, that the present invention is for a method of providing focused resources and managed infrastructure independent of any particular implementing system. Furthermore, though described for illustrative purposes in terms of a specific application, the present invention has broad application not limited to any particular one or type of concern.

As will be appreciated by those with ordinary skill in the art of computers, a wide variety of additional or alternative system organization and hardware, software, or firmware may be used in place of the preferred distributed system 10 or portions thereof. Furthermore, system requirements will vary depending upon the nature of the concern and the resources to be provided. A number of preferred but optional functions are described below, such as a smart card feature, each of which may require additional system components. The preferred system 10, able to implement all preferred options and features of the present invention, broadly comprises a national or regional data center 12; a city or regional hub 14; one or more regional education environments 16, and a wide area network (WAN) 18.

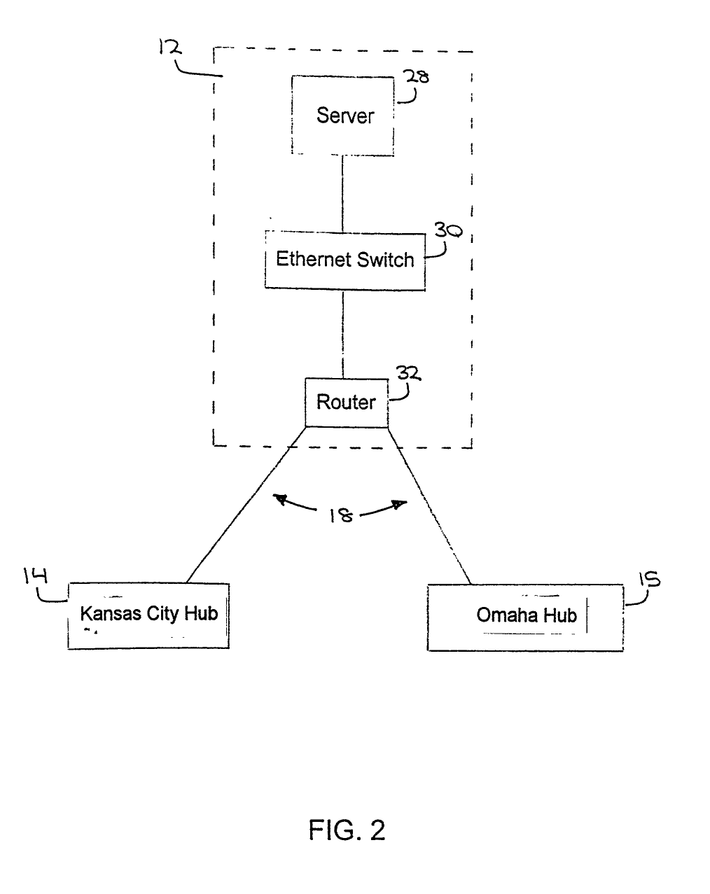

The data center 12 provides centralized administration and management of the focused resources and infrastructure on a national or regional level. In particular, the centralized data center 12 allows for efficient updating of content and services, and upgrading of hardware and software. Referring to FIG. 2, the data center 12 includes one or more servers 28 for delivering the resources to one or more hubs 14,15 via a conventional ethernet switch 30, router 32, and a suitable communications network, which may be, for example, land line, cable, wireless, or satellite-based.

Dedicated lines, Virtual Private Connections (VPCs), or other secure means allow secure communication with the educational environments 16. Firewalls and other known security features are interposed between the data center 12 and the educational environments 16 to ensure secure communications and system integrity, including protecting the integrity of data center data.

The hub 14 selectively connects the data center 12 to the educational environments 16. Delivery of resources from the hub 14 to any particular educational environment 16 may again be by any suitable communications network, including, for example, a land line, cable, wireless, or satellite-based network.

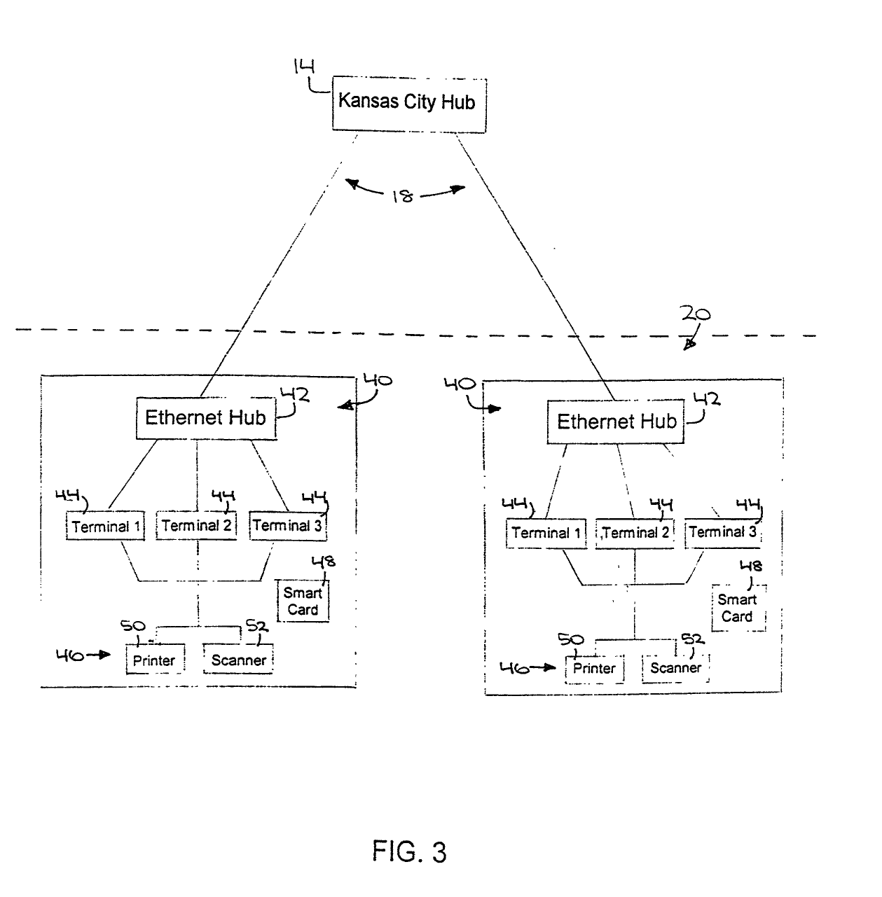

The educational environment 16 provides access points where members can use and benefit from the resources. The educational environment 16 may further comprise various member groups, including school districts 20,22 and other educational facilities 24, which may, in turn, include classrooms, school laboratories, administrative offices, etc. Referring to FIG. 3, for example, classroom infrastructure 40 is shown comprising an Ethernet switch or hub 42; one or more user terminals 44; peripheral equipment 46; and one or more smart cards 48.

The Ethernet switch or hub 42 is conventional and commonly available. The terminals 44 are preferably thin-client terminal devices. The thin-client device is a simple, low-cost terminal having little or no inherent processing ability and few critical components, making it preferred over conventional high-cost, relatively complex personal computers.

The peripheral equipment may include printers 50, scanners 52, or other conventional equipment as desired. Furthermore, the classroom infrastructure 40 may also include electronic switches (not shown) for maximizing port utilization and terminal-to-server connectivity.

The smart cards 48 are conventional, storing information magnetically, and operable to fill a number of roles, including user authentication and identification and financial functions. With regard to financial functions, the smart card 48 may be used as a credit or debit card associated with a user account, and operable to purchase concern-related items or services, such as school books, backpacks, or lunch, possibly from a school store or cafeteria. Account data is maintained at the data center 12 and can be accessed via the terminals 44 with proper authorization.

The WAN 18 may be any network, preferably the Internet, providing additional access to the resources via the hub 14. Thus, members may use and benefit from the resources from any location having an Internet connection, including their homes or workplaces. This is particularly advantageous for parents of students.

Related to infrastructure, the present invention provides ongoing training to the members of the concern. Extent and scope of training will vary depending upon the nature, needs, and desires of the concern, and may preferably be offered in tiered, cost-varying packages so as to allow for increased client choice and provider flexibility. Furthermore, such training may be of two types, traditional technical training regarding using the infrastructure and access the resources, and training regarding using the resources to accomplish the concern's goals (e.g., how to use the resources as effective education tools). The training may be delivered in a number of formats, including live pre-operation training, live in-service or ongoing training, help desk assistance (whether live or not), and user forums. Pre-operation training may include familiarization and strategy suggestion; in-service or ongoing training may include updates and periodic news letters. User forums may be web-based and open only to authorized users.

Furthermore, the present invention calls for responsiveness to particular concerns voiced through email, monitored chat rooms, or support or help lines, including adding, deleting, or otherwise changing the resources. This convenient, quick, and efficient responsiveness is a primary advantage of the present invention and can be provided because the customer need deal with only a single service provider for all their needs.

The nature of the focused resources made computer-accessible or otherwise delivered by the service provider will vary depending on the nature and needs of the concern and its members. In general, the resources may be characterized as belonging to one of two classes: content and services. A portion of these resources may be acquired from third-parties providers; another portion may be generated in-house.

Content includes such things as productivity, curricular, administrative, assessment, collaboration, and professional development programming and information. Productivity content includes such things as word processing, spreadsheet, and other software applications, such as those available from Microsoft and WordPerfect. Curricular content includes such things as curriculum alignment information for allowing educators to align their instruction and assessment with applicable standards and curriculum goals. Collaborative content includes such things as interactive (streaming) video providing remote access to professionals, lecturers, speakers, and events of interest.

Services may also be productivity, curricular, administrative, assessment, collaboration, and professional development in nature. Services include such things as communications, including email, unified messaging, and instant messaging, and secure chat/discussion groups. Administrative services include such things as usage tracking and notification (abuse, inappropriate/unsuitable use), web site hosting, filtered Internet access, student tracking, financials and billing, human resources, library management, news feeds, search engines, and financial functions for administering smart card use. Collaborative services include such things as distance learning and similar distribution of teaching or administrative expertise.

At least a portion of these resources are made available online via one or more vertically integrated portals (VIPs) tailored to the needs of one or more member subgroups (e.g., Administrator/Teacher; Parent; Age/Grade specific, including Pre-Third Grades, Fourth-Seventh Grades, and Eighth-Twelfth Grades; or School specific). Thus, convenient and efficient access is facilitated by the subgroup-specific VIPs which present certain subgroup-specific resources for quick selection and use. Any advertising present on these portals is preferably limited to relevant products and services, including suppliers catering to both schools, educators, administrators, students, and parents.

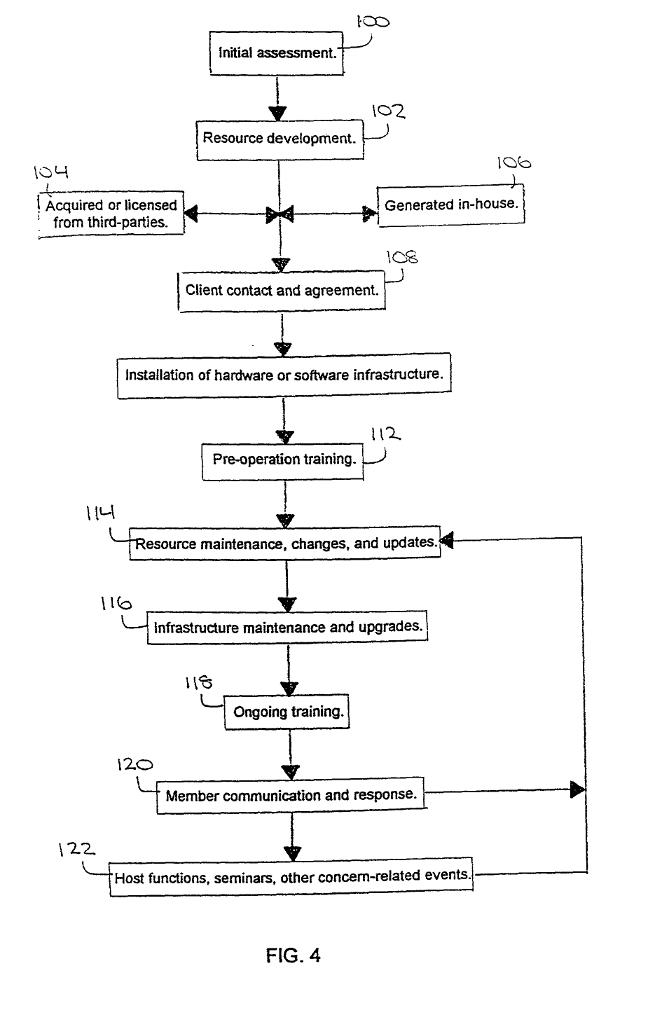

Referring to FIG. 4, to implement the present method, an initial unsolicited assessment may be performed to determine a concern's specific needs, as depicted in box 100. Where the particular concern is part of a larger concern or community already served, no or little additional content or services may be necessary or desired. However, where the particular concern may potentially benefit from the focused resources and managed infrastructure provided by the present invention, resources are developed tailored to the concern's specific needs and desires, as depicted in box 102. Such development may require creation from scratch or may simply require some degree of customization of existing resources. For example, once member-group specific portals have been created for a first school district, they may serve as templates for developing portal resources for other school districts, requiring only minimal customization. Note, however, that creation or customization of resources need not be accomplished by the method practitioner itself, particularly where it may not be cost-effective to do so. Thus, such development may be contracted to or otherwise acquired or licensed from third-parties, as depicted in box 104, generated in-house, as depicted in box 106, or produced by some combination thereof or by other means, as practical and desirable.

An example of services contracted to third-parties might include maintenance and upgrades of infrastructure. Rather than maintaining a local presence to provide this service, the practitioner of the present inventive method may find it more cost-effective to contract with a local service provider to accomplish this task. Concern communications on this issue may continue to be with the practitioner or may be directed to the local service provider for faster response.

Once the tailored resources are developed, the concern is contacted and an agreement reached as to providing needed hardware or software infrastructure, if any; member access and authorizations; extent and scope of desired administrative or service resources, such as the smart card/financial service; subscription rates, etc., as depicted in box 108.

Agreed upon hardware and software infrastructure is then installed, possibly including Ethernet hubs 42 and one or more terminals 44 and peripheral equipment 46, as depicted in box 110. Concerns with an existing well-developed hardware and software infrastructure may desire only access to the resources. Pre-operation training is provided with regard to using the infrastructure and accessing and using the resources to maximum benefit, as depicted in box 112.

Following these initial configuration and training steps and subsequent to the resources being made accessible to the concern, the resources are constantly or periodically updated, as depicted in box 114. Those resources for which constant updating may be desirable include, for example, administrative content and services such as usage tracking and notification; student tracking; financials and billing; news feeds; and financial functions, including administration of the smart card. Those resources for which periodic updating may be desirable include, for example, productivity content and services such as software, including word processing and spreadsheet programs; and curricular content and services such as instruction and assessment alignment information likely to change each semester or period. Infrastructure is also maintained and periodically upgraded as needed, as depicted in box 116; and ongoing training is provided as needed or desired, as depicted in box 118, to ensure continued maximization of use and benefit.

Also during this time, a concern member with a problem or comment, such as a suggestion for changing resources, may communicate with the service provider via email or telephone or other means, as depicted in box 120. Because the resources and infrastructure are provided by or through a single service provider, changes and adaptations to content, services, and infrastructure are easily and efficiently accomplished. For example, an educator who becomes aware of a desirable collaborative learning opportunity, such as a series of web-cast video lectures, may contact the practitioner of the present invention about acquiring, licensing, or otherwise making this series available to concern members. The benefit of this one-stop shopping, one-stop responsiveness, is that the concern and its members save valuable time and resources otherwise wasted on inefficient or redundant communications with multiple providers.

Resources need not be limited to those accessible by computer. Periodically, it may be desirable for the service provider to host functions or seminars related to the concern's functions and interests and attendable by concern members, as depicted in box 122. For example, where a concern is fairly large or far-flung, it may desirable to bring concern members together to meet and discuss common problems or trade solutions. Along that line, where a number of concerns are related, such as school districts which form a greater educational community, it may be desirable to host member-group specific events where, for example, administrators from various concerns can meet. Such events may also provide another opportunity for the service provider to gauge member needs and desires, and to add, delete, adapt, or change resources accordingly, as, for example, where a concern requests particular content or services recommended to it by another concern, or a member voices objection to content and those objections are generally echoed by other members.

Although the invention has been described with reference to the preferred embodiment illustrated in the attached drawing figures, it is noted that equivalents may be employed and substitutions made herein without departing from the scope of the invention as recited in the claims. For example, those with skill in the art will appreciate that numerous different infrastructural embodiments of hardware, software, firmware or combinations thereof exist for practicing the present invention. Furthermore, the nature of the concerns served may vary widely without departing substantially from the inventive method. Accordingly, the present invention should not be viewed as limited to the particular illustrative embodiment shown and described.

Having thus described the preferred embodiment of the invention, what is claimed as new and desired to be protected by Letters Patent includes the following:

1. A method of providing a range of resources to a concern, with the range of resources being limited to the functions and interests of the concern and at least a portion of the range of resources being computer-accessible over a communications network, the method comprising the steps of:
(a) customizing the range of resources to the concern, including acquiring a first portion of the range of resources and producing a second portion of the range of resources;
(b) offering an infrastructure necessary to access, via the communications network, at least a portion of the range of resources;
(c) providing the customized range of resources to the concern;
(d) changing the range of resources in response to communication from the concern; and
(e) upgrading the range of resources.

2. The method as set forth in claim 1, the content being selected from the group consisting of: productivity programming, curricular programming, administrative programming, assessment programming, collaboration programming, professional development programming.

3. The method as set forth in claim 1, the services being selected from the group consisting of: productivity programming, curricular programming, administrative programming, assessment programming, collaboration programming, professional development programming.

4. A method of providing a range of resources to a concern, with the range of resources being limited to the functions and interests of the concern and at least a portion of the range of resources being computer-accessible over a communications network, the method comprising the steps of:
(a) customizing the range of resources based upon the functions of the concern, including acquiring a first portion of the range of resources and generating a second portion of the range of resources;
(b) providing a hardware and software infrastructure necessary to access, via the communications network, at least a portion of the range of resources;
(c) providing training regarding the customized range of resources and the infrastructure;
(d) providing the customized range of resources to the concern;
(e) changing the customized range of resources in response to communication from the concern; and
(f) maintaining and upgrading the customized range of resources and the hardware and software infrastructure.

5. The method as set forth in claim 4, the content being selected from the group consisting of: productivity programming, curricular programming, administrative programming, assessment programming, collaboration programming, professional development programming.

6. The method as set forth in claim 4, the services being selected from the group consisting of: productivity programming, curricular programming, administrative programming, assessment programming, collaboration programming, professional development programming.

7. The method as set forth in claim 4, wherein step (c) includes providing both pre-operation training and ongoing in-service training.

8. The method as set forth in claim 4, further comprising the steps of:
(g) providing a financial account and a mechanism for accessing the account; and
(h) maintaining records relating to the account and use of the mechanism.

9. The method as set forth in claim 4, wherein the step (b) of providing hardware and software infrastructure is accomplished on a subscription basis.

10. A method of providing a range of resources to a concern, with the range of resources being limited to the functions and interests of the concern and at least a portion of the range of resources being computer-accessible over a communications network, the method comprising the steps of:
(a) customizing the range of resources based upon the needs and desires of the concern, including acquiring a first portion of the range of resources and generating a second portion of the range of resources;
(b) providing a hardware and software infrastructure necessary to access, via the communications network, at least a portion of the range of resources;
(c) providing training regarding the customized range of resources and the infrastructure;
(d) making at least a portion of the range of resources accessible to the concern via the infrastructure;
(e) providing a network portal customized to the needs and desires of a subgroup of the concern;
(f) changing the customized range of resources in response to communication from the concern; and
(g) maintaining and upgrading the customized range of resources and the hardware and software infrastructure.

11. The method as set forth in claim 10, further including the steps of:
(h) providing a financial account and a mechanism for accessing the account; and
(i) maintaining records relating to the account and use of the mechanism.

12. The method as set forth in claim 10, wherein the step (b) of providing hardware and software infrastructure is accomplished on a subscription basis.
